(19) United States
(12) Patent Application Publication
(10) Pub. No.: US 2016/0301886 A1
(43) Pub. Date: Oct. 13, 2016

(54) IMAGE PICKUP APPARATUS, IMAGE PICKUP SYSTEM, AND METHOD OF DRIVING AN IMAGE PICKUP APPARATUS

(71) Applicant: CANON KABUSHIKI KAISHA, Tokyo (JP)

(72) Inventors: Takashi Muto, Kawasaki-shi (JP); Daisuke Yoshida, Ebina-shi (JP)

(21) Appl. No.: 15/084,043

(22) Filed: Mar. 29, 2016

(30) Foreign Application Priority Data
Apr. 9, 2015 (JP) 2015-079804

(51) Int. Cl. H04N 5/378

(52) U.S. Cl. CPC H04N 5/378

(57) ABSTRACT

In order to reduce common source voltage fluctuations of a differential amplifier and to accomplish speed enhancement of reading operation, an image pickup apparatus is provided, including: a differential amplifier comprising a differential transistor and a current source, the differential transistor forming a differential pair with the pixel transistor and having a gate to which a ramp signal is input, the current source being configured to supply a current that flows in the differential pair; and a dummy pixel comprising a dummy pixel transistor in which one main node is electrically connected to one main node of the pixel transistor, and another main node is electrically connected to another main node of the pixel transistor.

### BACKGROUND OF THE INVENTION

1. Field of the Invention

The present invention relates to an image pickup apparatus, an image pickup system, and a method of driving an image pickup apparatus.

2. Description of the Related Art

In recent years, demands for a higher pixel count and a higher frame rate are increasing in the field of image pickup apparatus such as CMOS image sensors. With the development of CMOS process miniaturization technologies, image pickup apparatuses having an analog-to-digital converter have been devised. For example, in an image pickup apparatus disclosed in Japanese Patent Application Laid-Open No. 2005-311487, a comparison circuit that is included in an AD converter is provided with a differential transistor that forms a differential pair with an amplifier transistor of a unit pixel. A technology has been proposed in which the differential transistor cancels out threshold voltage fluctuations brought out by the body bias effect.

In Japanese Patent Application Laid-Open No. 2005-311487, the common source voltage of the transistors forming a differential pair is fluctuated due to the influence of field-through noise of a reset pulse or a transfer pulse, thereby deteriorating image quality. Avoiding this image deterioration requires a wait for solid stabilization of the common source voltage, which is a hindrance to further enhancement in speed.

### SUMMARY OF THE INVENTION

According to one embodiment of the present invention, there is provided an image pickup apparatus, including: a plurality of pixels each including a transfer transistor configured to transfer electric charges that are generated by photoelectric conversion, a pixel transistor having a gate to which the electric charges are input, and a reset transistor configured to reset the gate of the pixel transistor; a differential amplifier including a differential transistor and a current source, the differential transistor forming a differential pair with the pixel transistor and having a gate to which a ramp signal is input, the current source being electrically connected to the differential pair; and a dummy pixel including a dummy pixel transistor in which one main node is electrically connected to one main node of the pixel transistor, and another main node is electrically connected to another main node of the pixel transistor.

Further features of the present invention will become apparent from the following description of embodiments with reference to the attached drawings.

### BRIEF DESCRIPTION OF THE DRAWINGS

FIG. 1 is a circuit block diagram of an image pickup apparatus in a first embodiment of the present invention.

FIG. 2 is a circuit diagram of one column of pixels and a comparator for the column in the first embodiment of the present invention.

FIG. 3 is a timing chart of pixel signal reading operation in the first embodiment of the present invention.

FIG. 4 is a circuit diagram of one column of pixels and a comparator for the column in a second embodiment of the present invention.

FIG. 5 is a timing chart of pixel signal reading operation in the second embodiment of the present invention.

FIG. 6 is a circuit diagram of one column of pixels and a comparator for the column in a third embodiment of the present invention.

FIG. 7 is a circuit diagram of one column of pixels and a comparator for the column in a fourth embodiment of the present invention.

FIG. 8 is a circuit diagram of one column of pixels and a comparator for the column in a fifth embodiment of the present invention.

FIG. 9 is a timing chart of pixel signal reading operation in a sixth embodiment of the present invention.

FIG. 10 is a circuit diagram of one column of pixels and a comparator for the column in a seventh embodiment of the present invention.

FIG. 11 is a timing chart of pixel signal reading operation in the seventh embodiment of the present invention.

FIG. 12 is a circuit diagram of one column of pixels and a comparator for the column in an eighth embodiment of the present invention.

FIG. 13 is a timing chart of pixel signal reading operation in the eighth embodiment of the present invention.

FIG. 14 is a circuit block diagram of an image pickup apparatus in a ninth embodiment of the present invention.

FIG. 15 is a block diagram of an image pickup system in a tenth embodiment of the present invention.

### DESCRIPTION OF THE EMBODIMENTS

Preferred embodiments of the present invention will now be described in detail in accordance with the accompanying drawings. Each of the embodiments of the present invention described below can be implemented solely or as a combination of a plurality of the embodiments or features thereof where necessary or where the combination of elements or features from individual embodiments in a single embodiment is beneficial.

### First Embodiment

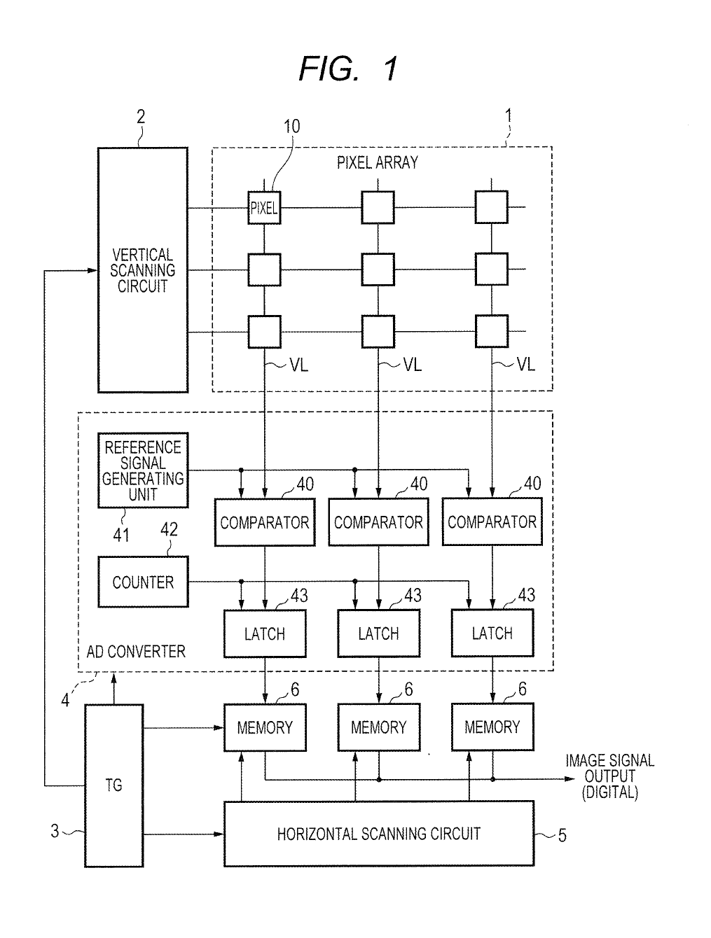

FIG. 1 is a circuit block diagram of an image pickup apparatus in a first embodiment of the present invention. The image pickup apparatus in this embodiment includes a pixel array 1, a vertical scanning circuit 2 configured to scan pixels, a timing generator (TG) 3 configured to control the operation of the image pickup apparatus, an AD converter 4 configured to convert a pixel signal into a digital signal, a horizontal scanning circuit 5, and memories 6. The pixel array 1 includes a plurality of pixels 10 arranged in a two-dimensional matrix along a row direction and a column direction. Only a limited number of pixels 10 of the pixel array 1, which can include n rows by m columns of pixels 10, are shown in FIG. 1 in order to simplify the description. The row direction herein is a horizontal direction in the drawings, and the column direction herein a vertical direction in the drawings. The pixel array 1 can also include a focal point detecting pixel configured to output a signal for focal point detection, an image pickup pixel configured to output a signal for generating an image, and an optical black (OB) pixel, which is shielded optically.

The vertical scanning circuit 2 receives a control signal from the TG 3 to scan and read the pixel array 1. Specifically, the vertical scanning circuit 2 supplies a signal to each pixel row made up of a plurality of pixels 10 in the horizontal direction, and reads a pixel signal out of the pixel row onto a relevant vertical signal line VL. The read pixel signal is converted from an analog signal into a digital signal by the AD converter 4 on a column by column basis.

The AD converter 4 includes comparators 40, a reference signal generating unit 41, a counter 42, and latches 43, and executes analog-to-digital conversion of a pixel signal. The reference signal generating unit 41 includes a digital-to-analog (DA) conversion circuit and a signal generating circuit to generate a reference signal that changes in voltage with time (a ramp signal). Each comparator 40 includes a differential amplifier configured to compare the voltage of a pixel signal to the voltage of the reference signal. The counter 42 is shared throughout all columns, and generates a counter value that is in sync with the reference signal. At the time when the result of the comparison in one comparator 40 is reversed, the relevant latch 43 holds the counter value. The counter value held in the latch 43 is output as a digital signal from the AD converter 4. The digital signal output from the AD converter 4 is stored in the relevant memory 6, and the horizontal scanning circuit 5 reads digital signals stored in the memories 6 in order.

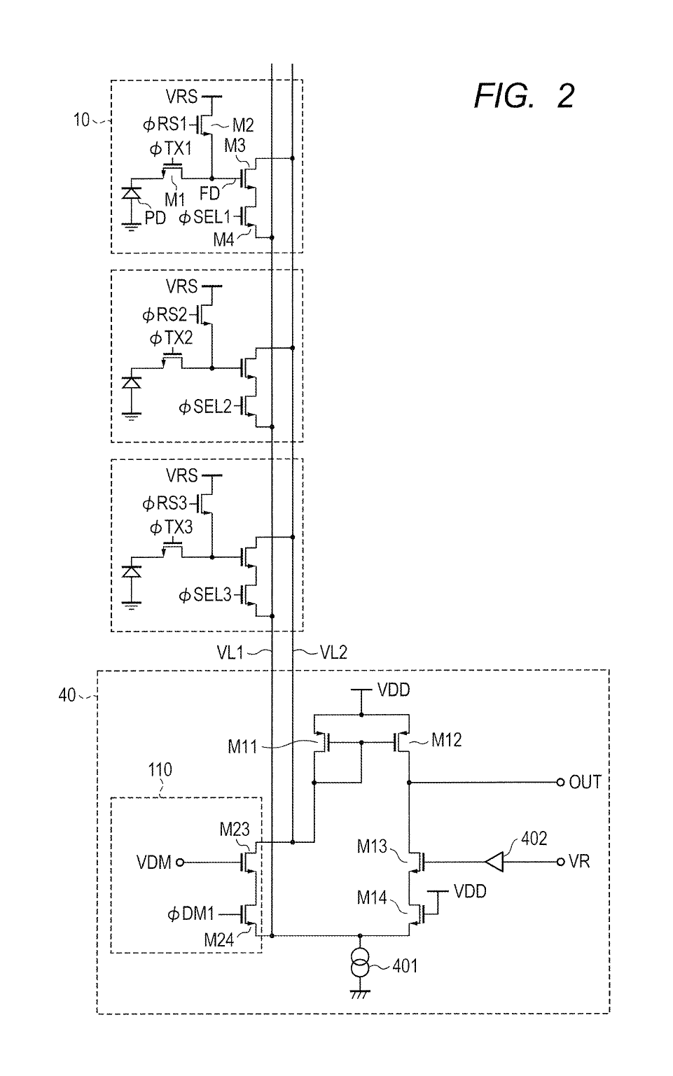

FIG. 2 is a circuit diagram for illustrating one column of pixels 10 and the comparator 40 for the column in the first embodiment. Each pixel 10 includes a photodiode PD, a floating diffusion node FD, a transfer transistor M1, a reset transistor M2, a pixel transistor M3, a selection transistor M4. Each pixel 10 may be configured so that the floating diffusion node FD, the reset transistor M2, t pixel transistor M3, and the selection transistor M4 are shared by a plurality of photodiodes PD. The transistor M2 to the transistor M4 are not limited to N-channel MOS transistors and may be P-channel MOS transistors.

The photodiode PD converts irradiated light into electrons (electric charges) through photoelectric conversion. A signal φTXn (n represents the row number) is supplied to a gate of the transfer transistor M1 and, when the signal φTXn shifts to the high level, the transfer transistor M1 transfers electric charges generated in the photodiode PD to the floating diffusion node FD. A signal φRSn (n represents the row number) is supplied to a gate of the reset transistor M2 and, when the signal φRSn shifts to the high level, the reset transistor M2 resets the voltage of the floating diffusion node FD to a reset voltage VRS. Turning the transfer transistor M1 and the reset transistor M2 on concurrently resets electrons in the photodiode PD. A gate of the pixel transistor M3 is connected to the floating diffusion node FD.

A drain of the pixel transistor M3 which is one of main nodes of the pixel transistor M3 is electrically connected to a vertical signal line VL2 (a second signal line), which is provided for each column to be shared by the pixels 10 that are in the same column. The selection transistor M4 is provided on an electrical path between a source of the pixel transistor M3 and a current source 401. In other words, the source of the pixel transistor M3 which is the other main node of the pixel transistor M3 is electrically connected via the selection transistor M4 to a vertical signal line VL1 (a first signal line), which is provided for each column to be shared by the pixels 10 that are in the same column. It can also be said that the source of the pixel transistor M3 is electrically connected to the current source 401. A signal φSELn (n represents the row number) is applied to a gate of the selection transistor M4 and, when the signal φSELn shifts to the high level, the pixel transistor M3 is electrically connected to the vertical signal line VL1. A pixel signal is thus read out of the selected pixel 10.

The comparator 40 includes P-channel MOS transistors M11 and M12, a differential transistor M13, which is an N-channel MOS transistor, a transistor M14, a dummy pixel 110, the current source 401, and a buffer 402. A reference signal VR (ramp signal) output from the reference signal generating unit 41 is input to a gate of the differential transistor M13 via the buffer 402. A source of the differential transistor M13 is connected to the vertical signal line VL1 via the transistor M14, which has a gate connected to a power supply voltage VDD. The differential transistor M13 accordingly forms a differential pair with the pixel transistor M3 of the selected pixel 10, with the vertical signal line VL1 as a common source. The common source (the vertical signal line VL1) of the differential pair is supplied a current from the current source 401.

A source of the transistor M11 and a source of the transistor M12 are connected to the power supply voltage VDD. A gate of the transistor M11 and a gate of the transistor M12 are connected to each other. The gate of the transistor M11 is also connected to a drain of the transistor M11. The transistors M11 and M12 form a current mirror pair having a mirror ratio of 1, and can accordingly have a current flow equal to each other. The gate and drain of the transistor M11 are connected to the vertical signal line VL2. A current from the transistor M11, which is a half of the current mirror pair, therefore flows into the current source 401 via the pixel transistor M3 and selection transistor M4 of the selected pixel 10. A current from the transistor M12, which is the other half of the current mirror pair, flows into the current supply 401 via the differential transistor M13 and the transistor M14.

A differential amplifier is configured in the manner described above, with the gate of the pixel transistor M3 of the selected pixel 10 and the gate of the differential transistor M13 as input terminals and a drain of the differential transistor M13 as an output terminal OUT. In other words, a result of comparing the voltage of the floating diffusion node FD of the selected pixel 10 to the reference signal VR is output from the output terminal OUT. When the reference signal VR is higher than the voltage of the floating diffusion node FD, a low level signal is output from the output terminal OUT. When the reference signal VR is lower than the voltage of the floating diffusion node FD, a high level signal is output from the output terminal OUT.

The dummy pixel 110, which includes a dummy pixel transistor M23 and a transistor M24, is connected to the differential amplifier described above. A drain of the dummy pixel transistor M23 which is one of main nodes of the dummy pixel transistor M23 is connected to the vertical signal line VL2. It can also be said that the drain of the dummy pixel transistor M23 is electrically connected to the drain of the pixel transistor M3. The transistor M24 is provided on an electrical path between a source of the dummy pixel transistor M23 which is the other main node of the dummy pixel transistor M23 and the current source 401. In other words, the source of the dummy pixel transistor M23 which is the other main node of the dummy pixel transistor M23 is connected to the vertical signal line VL1 via the transistor M24. It can also be said that the source of the dummy pixel transistor M23 is electrically connected to the current source 401. A dummy pixel voltage VDM is applied to a gate of the dummy pixel transistor M23, and a signal φDM1 is applied to a gate of the transistor M24. In a substitute current period in which the signal φDM1 is at the high level, a source of the transistor M24 is electrically connected to the vertical signal line VL1. This enables the dummy pixel transistor M23 to cause, in the differential amplifier, a flow of current that is a substitute for the current of the pixel transistor M3, which reduces common source voltage fluctuations caused by the field-through noise of the signals φRS or the signals φTX.

The dummy pixel transistor M23 and the transistor M24 are desirably configured so as to have characteristics equivalent to those of the pixel transistor M3 and selection transistor M4 of each pixel 10. This may make the current of the dummy pixel 110 match with the current of each pixel 10 and, when the dummy pixel 110 causes in the differential amplifier a flow of current that is a substitute for the current of the pixel 10, further reduces common source voltage fluctuations. A premise of the following description is that these transistors have configurations equivalent to one another.

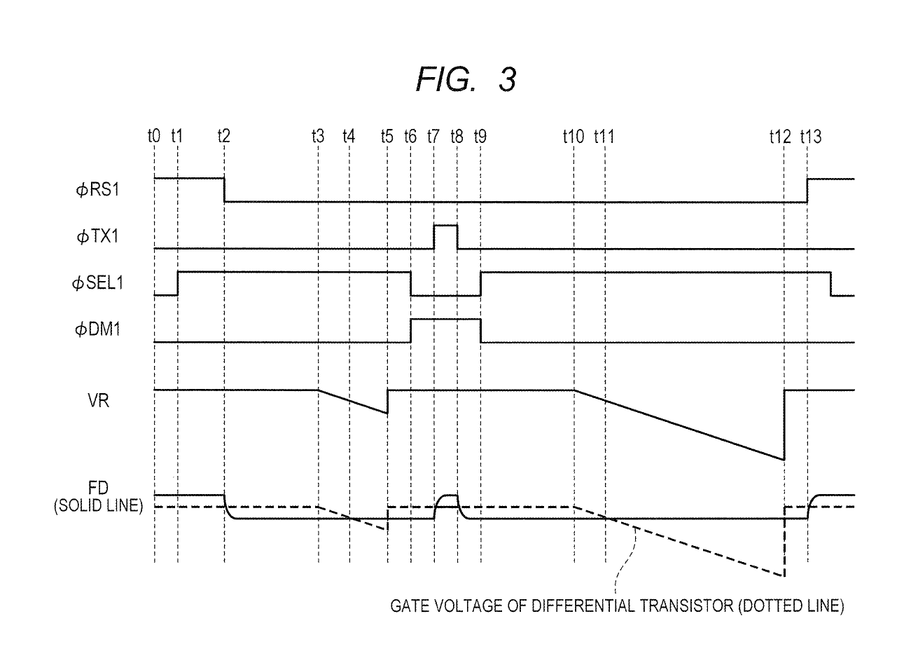

FIG. 3 is a timing chart of the pixel signal reading operation in this embodiment. Given here as an example is a timing chart of the operation of reading pixel signals of the first row.

At a time t0, the vertical scanning circuit 2 sets the signal φRS1 to the high level and the signal φTX1 to the low level. As a result, the reset transistor M2 is turned on, the transfer transistor M1 is turned off, and the floating diffusion node FD is reset in each pixel 10 in the first row. At a time t1, where the signal φSEL1 shifts to the high level, the selection transistor M4 is turned on, and the pixel transistor M3 forms a differential pair with the differential transistor M13 of the relevant comparator 40. In other words, the comparator 40 is put into a state where the comparator 40 can output the result of comparing the voltage of the gate of the pixel transistor M3, i.e., the floating diffusion node FD, to the reference signal VR.

At a time t2, a shift of the signal φRS1 to the low level turns the reset transistor M2 off, which causes the floating diffusion node FD to hold the reset voltage VRS. The floating diffusion node FD at this point changes to a voltage lower than the reset voltage VRS due to the field-through noise of the signal φRS1. At a time t3, the initial voltage of the reference signal VR is set higher than a voltage that the floating diffusion node FD has after the signal φRS1 shifts to the low level. A low level signal is therefore output from the output terminal OUT at the time t3. Thereafter, the reference signal generating unit 41 decreases (ramps down) the voltage of the reference signal VR with time and, at a time t4, the result of the comparison of the floating diffusion node FD to the reference signal VR is reversed, thereby causing a high level signal to be output from the output terminal OUT. The counter value of the counter 42 at the time t4 is held in the relevant latch 43 as an AD conversion result. In other words, a pixel signal based on the voltage at the time when the pixel 10 is reset is converted through AD conversion. In the following description, the AD conversion of a pixel signal based on the voltage at the time of reset is referred to as N-conversion. At a time t5, which is after the N-conversion, the reference signal generating unit 41 sets the reference signal VR back to the initial voltage.

At a time t6, a shift of the signal φDM1 to the high level turns the transistor M24 on, thereby activating the dummy pixel 110. The signal φSEL1 shifts to the low level at the same time, which turns off the selection transistor M4 of the pixel 10. In the next period from a time t7 to a time t8, a shift of the signal φTX1 to the high level turns the transfer transistor M1 on, and electric charges accumulated in the photodiode PD are transferred to the floating diffusion node FD. After the transfer of the electric charges, a shift of the signal φSEL1 to the high level turns the selection transistor M4 on at a time t9. At the same time, a shift of the signal φDM1 to the low level turns off the transistor 24 of the dummy pixel 110. In the substitute current period where the signal φDM1 is at the high level (from the time t6 to the time t9), the dummy pixel voltage VDM is set to a voltage equivalent to one that the floating diffusion node FD has after a pixel reset. The differential transistor M13 and the dummy pixel transistor M23 therefore form a differential pair in the substitute current period. A current flowing in the pixel transistor M3 before the time t6 flows in the dummy pixel transistor M23 during the substitute current period.

A voltage that the floating diffusion node FD has at the time t7 and in the subsequent period when an image of a black subject is picked up is shown in the timing chart. While the voltage of the floating diffusion node FD in the shooting of a black subject fluctuates due to the field-through noise of the signal φTX1, the common source voltage fluctuations of the relevant comparator 40 are reduced by the dummy pixel 110. The length of time till a definite result of AD conversion is obtained is shorter when the color of the shooting subject is black than when the color of the shooting subject is white. Common source voltage fluctuations are therefore reduced in the shooting of a black subject, and AD conversion that follows can be started earlier (at a time t10). According to the image pickup apparatus and driving method of this embodiment, the reading of pixel signals is made quicker.

At the time t10, the reference signal generating unit 41 decreases the voltage of the reference signal VR with time. At a time t11, the result of the comparison of the floating diffusion node FD to the reference signal VR is reversed, thereby causing a high level signal to be output from the output terminal OUT. The counter value of the counter 42 at this point is held in the relevant latch 43 as an AD conversion result. A pixel signal that is based on electric charges accumulated in the photodiode PD is converted through AD conversion in this manner. In the following description, the AD conversion of a pixel signal that is based on electric charges accumulated in the photodiode PD is referred to as S-conversion. Thereafter, the reference signal VR returns to the initial voltage at a time t12, and a shift of the signal φRS1 to the high level at a time t13 resets the floating diffusion node FD. The two pixel signals obtained through the N-conversion and the S-conversion are then processed by correlated double sampling to obtain a pixel signal that is the post-S-conversion pixel signal from which a noise component generated in the reset is removed.

As described, according to this embodiment, the dummy pixel transistor M23 in place of the pixel transistor M3 forms a differential pair with the differential transistor M13 in the substitute current period, which includes a period where the transfer transistor M1 is turned on. This reduces common source voltage fluctuations of the differential amplifier, and allows the start time of the AD conversion of the pixel signal to be pushed up without impairing the precision of the AD conversion. The substitute current period (from the time t6 to the time t9) in which the signal φDM1 is at the high level does not always need to coincide with the period in which the signal φSEL1 is at the low level. For example, the same effects are accomplished when the substitute current period in which the signal φDM1 is at the high level includes the period in which the signal φSEL1 is at the low level. The dummy pixel transistor M23 and the pixel transistor M3 do not always need to have equivalent characteristics, and the same effects can be accomplished by adjusting the dummy pixel voltage VDM.

Each pixel 10, which includes the selection transistor M4 in this embodiment, may not have the selection transistor M4. The selection of one pixel 10 in this case is made by setting the electric potential of the gate of the pixel transistor M3. Specifically, a reset voltage VRS1 for not selecting the pixel 10 and a reset voltage VRS2 for selecting the pixel 10 are selectively supplied as the reset voltage VRS, which is supplied to the reset transistor M2. The reset voltage VRS1 is supplied to the reset transistor M2 of the pixel 10 that is not to be selected, and the vertical scanning circuit 2 sets the signal φRS to the high level for the unselected pixel 10 as well. This sets the gate electric potential of the pixel transistor M3 to an electric potential based on the reset voltage VRS1, and the pixel 10 is thus not selected. To select one pixel 10, on the other hand, the reset voltage VRS2 is supplied to the reset transistor M2 of the pixel 10 and the vertical scanning circuit 2 sets the signal φRS to the high level for the pixel 10 as well. This sets the gate electric potential of the pixel transistor M3 to an electric potential based on the reset voltage VRS2, and the pixel 10 is thus selected. Because each pixel 10 here is provided with no selection transistor 114, it is preferred to omit the transistor M24 from the dummy pixel 110 as well. The dummy pixel voltage VDM in this case takes a plurality of voltage values as the reset voltage VRS1 and the reset voltage VRS2 to make a switch between the turning on of the dummy pixel transistor 1123 and the turning off of the dummy pixel transistor M23. The dummy pixel transistor M23 is provided in the pixel array 1 where the pixels 10 are arranged. This makes it easier to match the characteristics of the dummy pixel transistor M23 to the characteristics of the pixel transistor M3.

### Second Embodiment

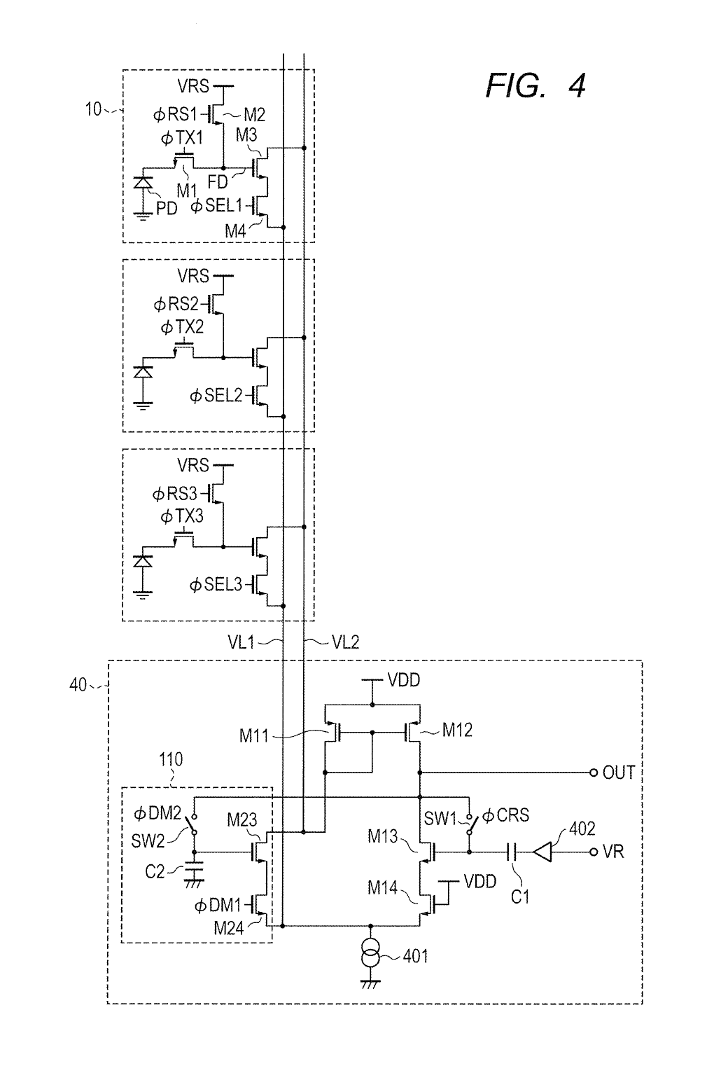

FIG. 4 is a circuit diagram for illustrating one column of pixels 10 and the comparator 40 for the column in a second embodiment of the present invention. This embodiment differs from the first embodiment in the configurations of the portion to which the reference signal VR is input and the dummy pixel 110. The differences from the first embodiment are described mainly below.

In the comparator 40, a capacitance C1 first capacitance) is inserted between the gate of the differential transistor M13 and the buffer 402. The gate of the differential transistor M13 can be connected electrically to the output terminal OUT via a switch SW1, which is controlled with a signal CRS. When the signal φCRS shifts to the high level, electrical connection is established in the switch SW1 and the drain and gate of the differential transistor M13 are short-circuited. In the dummy pixel 110, the gate of the dummy pixel transistor M23 is connected to one end of a capacitance C2 to second capacitance) and the other end of the capacitance C2 is grounded. The gate of the dummy pixel transistor M23 can be connected electrically to the output terminal OUT via a switch SW2, which is controlled with a signal φDM2. When the signal φDM2 shifts to the high level, electrical connection is established in the switch SW2. The rest of the configuration is the same as in the first embodiment.

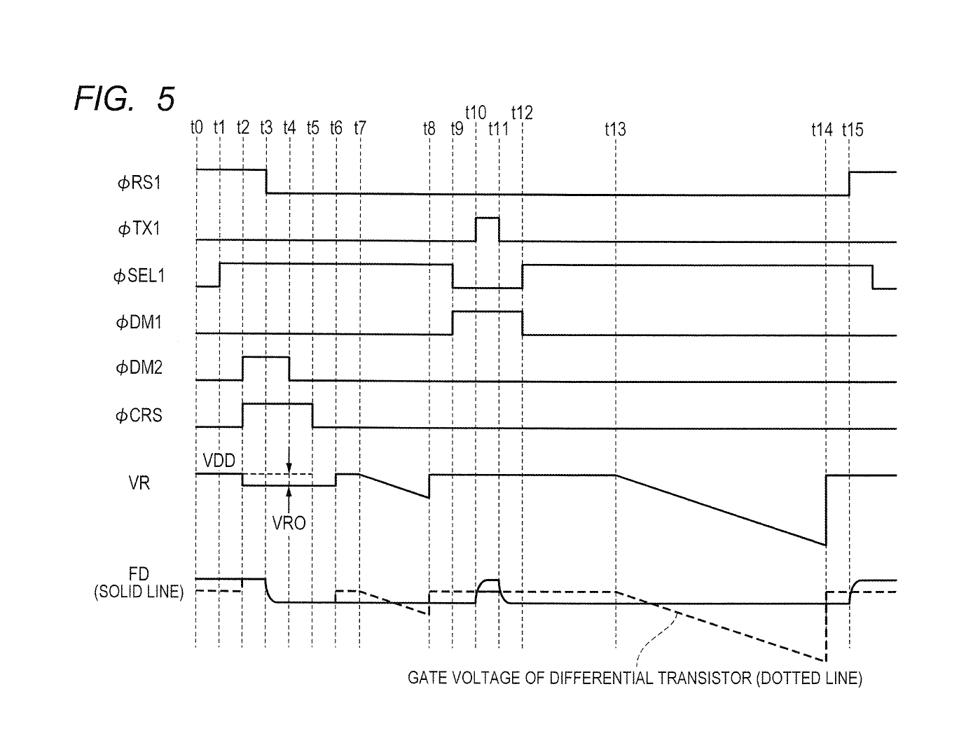

FIG. 5 is a timing chart of the pixel signal reading operation in this embodiment. At a time t0, the signal φRS1 is set to the high level and the signal φTX1 is set to the low level. As a result, the reset transistor M2 is turned on, the transfer transistor M1 is turned off, and the floating diffusion node FD is reset in each pixel 10 in the first row. At the time t1, the signal φSEL1 shifts to the high level and the selection transistor M4 is turned on. The pixel transistor M3 forms a differential pair with the differential transistor M13 of the relevant comparator 40, and the result of comparing the voltage of the floating diffusion node FD to the reference signal VR is output from the output terminal OUT.

At the time t2, a shift of the signal φCRS to the high level switches on the switch SW1. The gate of the differential transistor M13 is electrically connected to the output terminal OUT at this point. In other words, the comparator 40 functions as a voltage follower in which an output and inverting input of the differential amplifier are short-circuited. This gives the gate of the differential transistor M13 the same voltage as that of the floating diffusion node FD. A shift of the signal φDM2 to the high level switches on the switch SW2, thereby applying the voltage of the floating diffusion node FD to the gate of the dummy pixel transistor M23 and the capacitance C2.

At the time t3, a shift of the signal φRS1 to the low level turns the reset transistor M2 off. The floating diffusion node FD holds a voltage lower than the reset voltage VRS due to the field-through noise of the signal φRS1. After the voltage of the floating diffusion node FD settles steadily, the signal φDM2 shifts to the low level at the time t4. This switches off the switch SW2 and the capacitance C2 holds the same voltage as that of the floating diffusion node FD.

At the time t5, a shift of the signal φCRS to the low level switches off the switch SW1. This closes the connection between the gate and drain of the differential transistor M13, and the comparator 40 operates as a comparator. The gate of the differential transistor M13 holds the same voltage as that of the floating diffusion node FD. The reference signal generating unit 41 outputs the reference signal VR that is lower than the power supply voltage VDD by a constant offset voltage VR0 before the signal φCRS shifts to the low level. During this period, the capacitance C1 accumulates electric charges in an amount determined by the offset voltage VR0 and the gate voltage of the differential transistor M13, and keeps the electric charges after the signal φCRS shifts to the low level as well. The gate of the differential transistor M13 holds the same voltage as that of the floating diffusion node FD, and the gate voltage of the differential transistor M13 therefore changes by the same amount as the amount of change of the reference signal VR with respect to the voltage of the floating diffusion node FD. Accordingly, when the reference signal VR rises by the offset voltage VR0 to the power supply voltage VDD at the time t6, the gate voltage of the differential transistor M13 rises by the offset voltage VR0 with respect to the voltage of the floating diffusion node FD. The gate voltage of the differential transistor M13 in the N-conversion period and the S-conversion period changes the same way as the reference signal VR, and the voltage of the floating diffusion node FD is compared to the reference signal VR. The offset voltage VR0 is therefore desirably set so that the pixel signal does not exceed the range of AD conversion in the N-conversion.

In the period from the time t7 to the time t8, the comparator 40 compares the floating diffusion node FD to the reference signal VR, and a counter value that is registered at the time when the result of the comparison is reversed is held in the relevant latch 43 as an AD conversion result. The N-conversion of a pixel signal based on the reset voltage is thus executed.

After the N-conversion, pixel transfer and S-conversion are executed as in the first embodiment. The gate voltage of the differential transistor M13 changes the same way as the reference signal VR in the N-conversion period and the S-conversion period as well, and the voltage of the floating diffusion node FD is therefore compared to the reference signal VR in the same manner as in the first embodiment. Specifically, the reference signal generating unit 41 sets the reference signal VR back to the power supply voltage VDD at the time t8, and a shift of the signal φSEL1 to the low level at the time t9 turns the selection transistor M4 off. At the same time, a shift of the signal φDM1 to the high level turns the transistor M24 on, thereby activating the dummy pixel 110. In a period from the time t10 to the time t11, a shift of the signal to the high level turns the transfer transistor M1 on, and electric charges accumulated in the photodiode PD are transferred to the floating diffusion node FD. In a period from the time t9 to the time t12, the differential transistor M13 and the dummy pixel transistor M23 form a differential pair, and the dummy pixel transistor M23 causes in the differential amplifier a flow of current that is a substitute for the current of the pixel transistor M3. While the voltage of the floating diffusion node FD fluctuates in the shooting of a black subject due to the field-through noise of the signal φTX1, the common source voltage fluctuations of the comparator 40 are reduced by the dummy pixel 110. The length of time till the common source voltage settles is thus cut short, and speed enhancement is accomplished while reducing a drop in signal precision.

In a period from the time t13 to a time t14, the comparator 40 compares the voltage of the floating diffusion node FD and the gate voltage of the differential transistor M13 to execute the AD conversion of a pixel signal that is based on electric charges accumulated in the photodiode PD (S-conversion). Thereafter, a shift of the signal φRS1 to the high level at a time t15 resets the floating diffusion node FD.

In this embodiment, the voltage of the floating diffusion node FD is applied to the gate of the dummy pixel transistor M23 by the voltage follower. The gate voltage of the dummy pixel transistor M23 can therefore be controlled in a manner suited to fluctuations from one pixel to another. This reduces common source voltage fluctuations even more, and speed enhancement accomplished. Another advantage of this embodiment is found when the input offset of the comparator 40 fluctuates greatly, which necessitates in the first embodiment the setting of an AD conversion range that is wider than the range of input to accommodate the greatly fluctuating input offset. In this embodiment, on the other hand, the voltage follower that uses negative feedback sets for each pixel the initial value of the gate voltage of the differential transistor M13 to the voltage of the floating diffusion node FD. This enables the comparator 40 to compare the voltage of the floating diffusion node FD to the reference signal VR while canceling out the input offset. The need to set an AD conversion range that takes into account fluctuations of the input offset is therefore eliminated.

### Third Embodiment

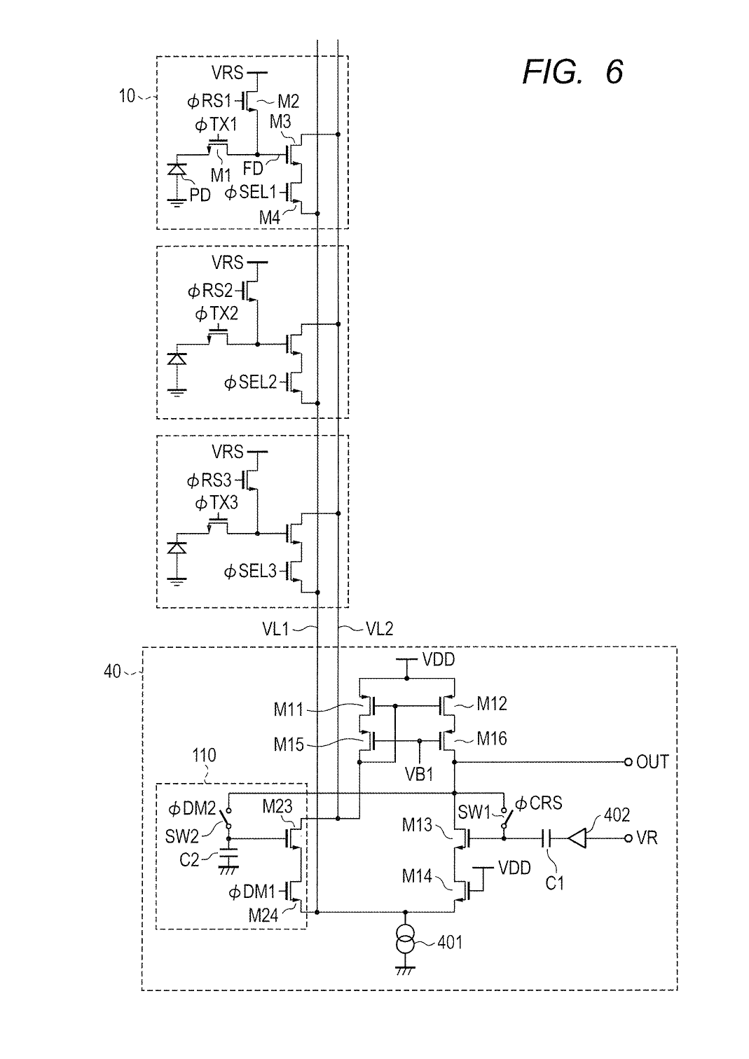

FIG. 6 is a circuit diagram for illustrating one column of pixels 10 and the comparator 40 for the column in a third embodiment of the present invention. This embodiment differs from the second embodiment in the configuration of a load of the differential pair. The differences from the second embodiment are described mainly below.

The comparator 40 further includes transistors M15 and M16, which are P-channel MOS transistors. A bias voltage VB1 is applied to a gate of the transistor M15 and a gate of the transistor M16. A drain of the transistor M12 is electrically connected to the drain of the differential transistor M13 via the transistor M16. The drain of the transistor M11 is electrically connected to the vertical signal line VL2 via the transistor M15. The gate of the transistor M11 and a gate of the transistor M12 are electrically connected to the vertical signal line VL2. The transistors M11, M12, M15, and M16 therefore form a cascode current mirror group, and function as a load of the differential pair. In this embodiment also, a differential amplifier is configured that has the floating diffusion node FD of the selected pixel 10 as a non-inverting input terminal and the gate of the differential transistor M13 as an inverting input terminal. The differential amplifier can operate as a voltage follower or a comparator selectively by the switching of the switch SW1. Pixel signal reading operation in this embodiment is as illustrated in FIG. 5. The same effects as those in the second embodiment can therefore be obtained in this embodiment.

### Fourth Embodiment

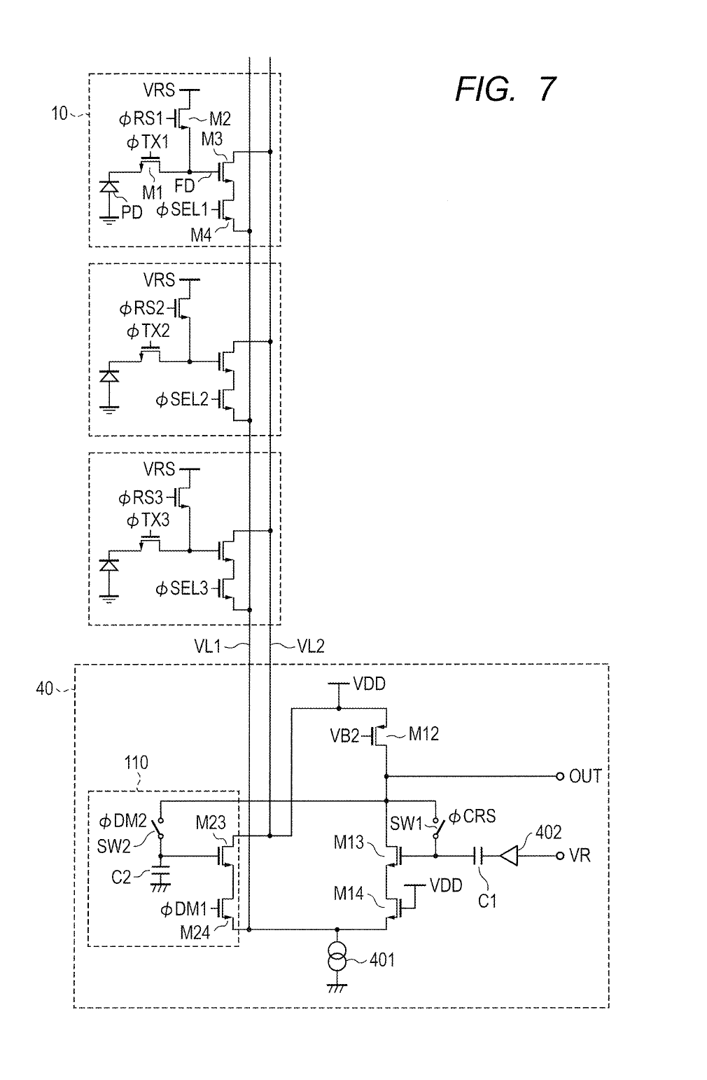

FIG. 7 is a circuit diagram for illustrating one column of the pixel array 1 and the comparator 40 for the column in a fourth embodiment of the present invention. This embodiment differs from the second embodiment in the configurations of the load of the differential pair. The differences from the second embodiment are described mainly below.

In this embodiment, the transistor M12 is provided in a half of a differential pair. A bias voltage VB2 is applied to the gate of the transistor M12, and the transistor M12 operates as a current source. In the other half of the differential pair, the vertical signal line VL2 is electrically connected to the power supply voltage VDD. In this embodiment also, a differential amplifier is configured that has the output terminal OUT as an output, the floating diffusion node FD of the selected pixel 10 as a non-inverting input, and the gate of the differential transistor M13 as an inverting input terminal. The same effects as those in the second embodiment can therefore be obtained in this embodiment.

### Fifth Embodiment

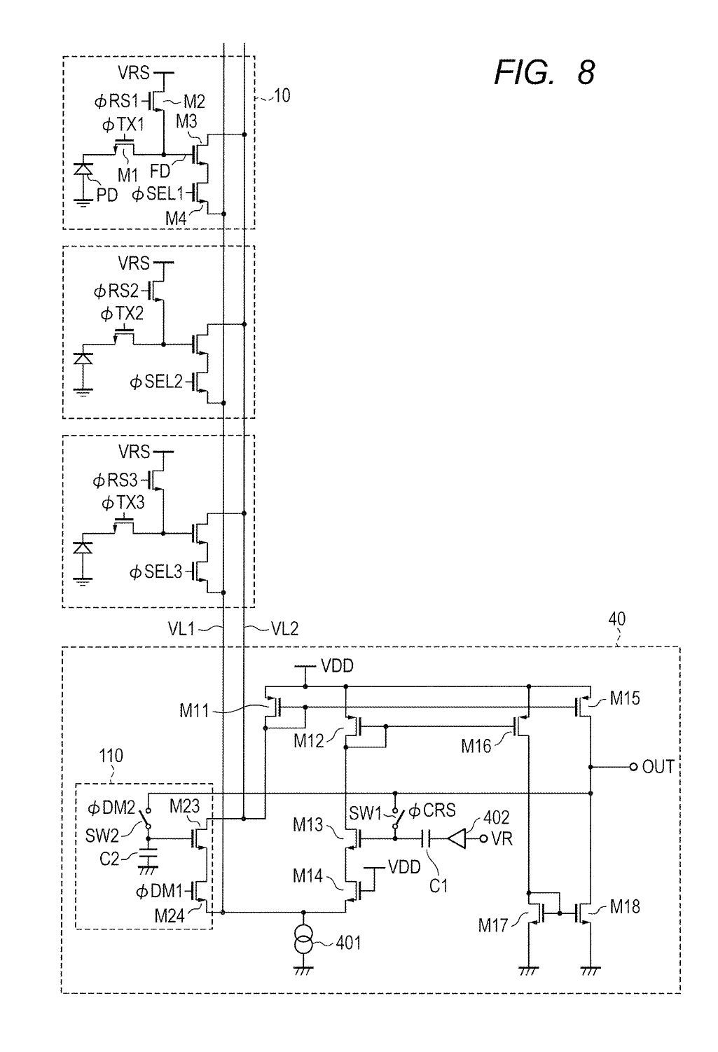

FIG. 8 is a diagram for illustrating one column of the pixel array 1 and the comparator 40 for the column in a fifth embodiment of the present invention. This embodiment differs from the second embodiment in the configuration of the load of the differential pair. The differences from the second embodiment are described mainly below.

The comparator 40 further includes transistors M15 and M16, which are P-channel MOS transistors, and transistors M17 and M18, which are N-channel MOS transistors. The transistor M15 forms a current mirror pair with the transistor M11, and the transistor M16 forms a current mirror pair with the transistor M12. The transistors M17 and M18 form another current mirror pair. In the current mirror pair made up of the transistors M12 and M16, the transistor M16 outputs the same current as the drain current of the differential transistor M13. Currents flowing in the transistors M17 and M18, which form a current mirror pair, are the same. Currents flowing in the transistors M11 and M15, which form a current mirror pair, are also the same. The same current as the drain current of the differential transistor M13 flows in the transistor M15. A drain of the transistor M15 and a drain of the transistor M18 are connected to each other to serve as the output terminal OUT. The output terminal OUT is connected to two input terminals of the differential amplifier via the switches SW1 and SW2, respectively,

In this embodiment also, a differential amplifier is configured that has the output terminal OUT as an output, the floating diffusion node FD of the selected pixel 10 as a non-inverting input, and the gate of the differential transistor M13 as an inverting input terminal. The same effects as those in the second embodiment can therefore be obtained.

### Sixth Embodiment

An image pickup apparatus in a sixth embodiment of the present invention is described next. This embodiment differs from the first embodiment in operation timing. The difference from the first embodiment is described mainly below.

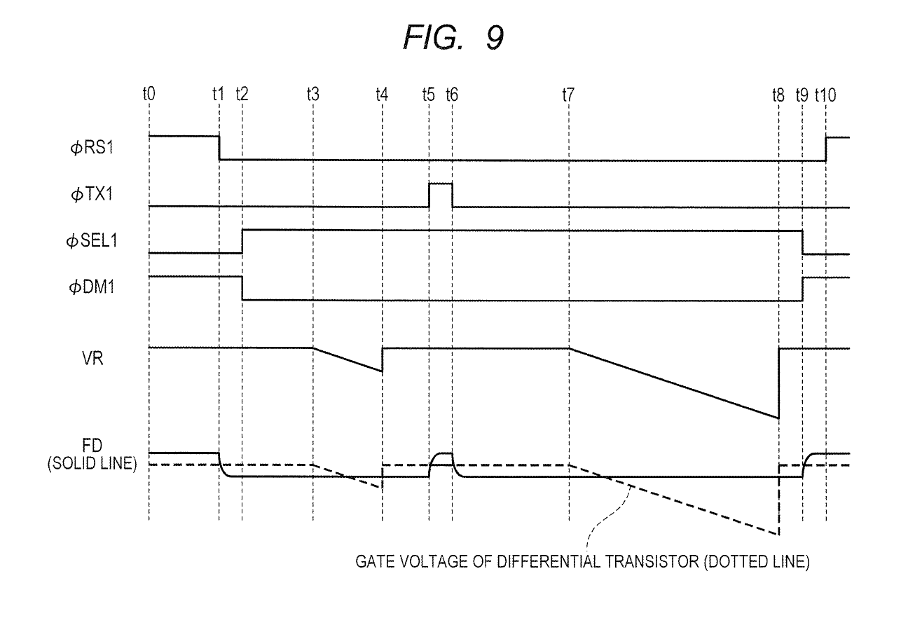

FIG. 9 is a timing chart of pixel signal reading operation in this embodiment. At the time t0, the vertical scanning circuit 2 sets the signal φRS1 to the high level and the signal φTX1 to the low level. This resets the floating diffusion node FD. At the time t1, a shift of the signal φRS1 to the low level changes the voltage of the floating diffusion node FD to one that is lower than the reset voltage VRS due to the field-through noise of the signal φRS1. In a period till the voltage of the floating diffusion node FD settles (the time t2) from the initial state (the time t0), the vertical scanning circuit 2 keeps the signal φSEL1 at the low level and the signal φDM1 at the high level. Accordingly, the transistor M24 of the dummy pixel 110 is turned on and a differential amplifier to which the dummy pixel voltage VDM and the reference signal VR are input is configured.

At the time t2, the vertical scanning circuit 2 sets the signal φSE1 to the high level and the signal φDM1 to the low level. A differential amplifier to which the voltage of the floating diffusion node FD of the selected pixel 10 and the reference signal VR are input configured as a result. At the time t3, the reference signal generating unit 41 decreases the voltage of the reference signal VR with time to execute N-conversion. The dummy pixel voltage VDM at this point is set to a voltage that the floating diffusion node FD has after the reset, and the common source voltage of the differential amplifier therefore does not fluctuate in a period from the initial state to the N-conversion. The length of time till the N-conversion from the pixel reset is accordingly cut short.

After the N-conversion is completed at the time t4, the vertical scanning circuit 2 sets the signal φTX1 to the high level and electric charges are transferred from the photodiode PD to the floating diffusion node FD in a period from the time t5 to the time t6. At the time t7, the reference signal generating unit 41 changes the voltage of the reference signal VR, with time to execute conversion. After the S-conversion is completed at the time t8, the vertical scanning circuit 2 sets the signal φSEL1 to the low level and the signal φDM1 to the high level at the time t9. At the time t10, the vertical scanning circuit 2 sets the signal φRS1 to the high level, thereby putting the pixels 10 of the next row into an initial state for reading.

According to this embodiment, common source voltage fluctuations in a reset are reduced, and the reading of pixel signals is made accordingly quicker.

### Seventh Embodiment

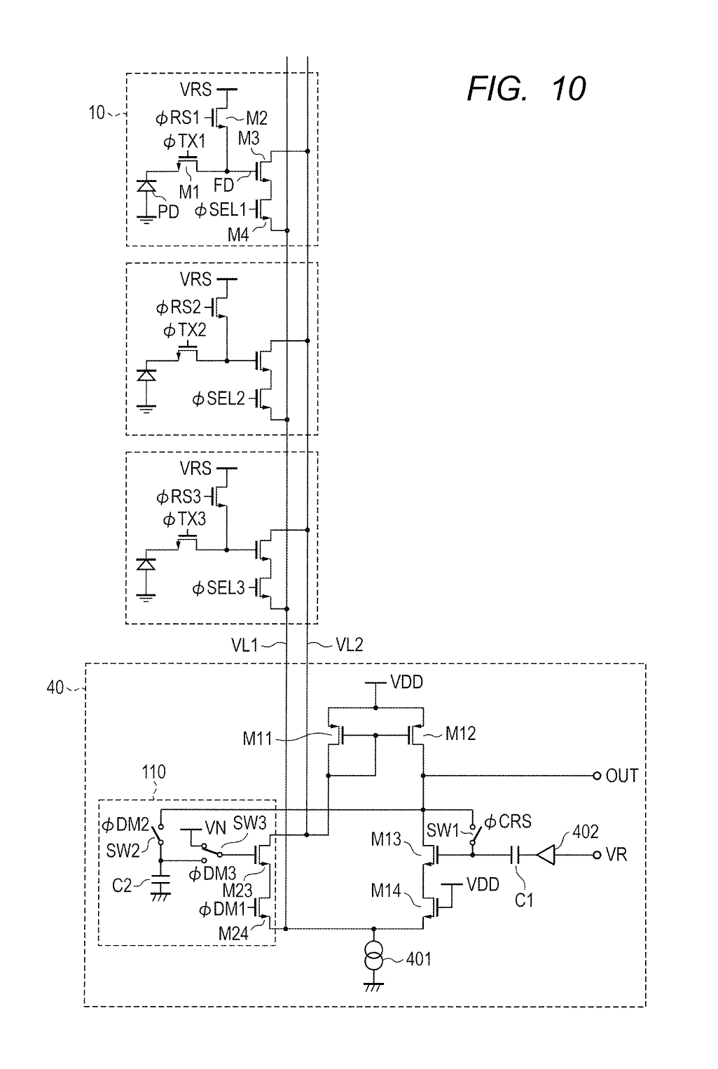

FIG. 10 is a circuit diagram for illustrating one column of the pixel array 1 and the comparator 40 for the column in a seventh embodiment. This embodiment differs from the second embodiment in the configuration of the dummy pixel 110, and provides an additional effect of diminishing a phenomenon called darkening which occurs at a high luminance. The darkening is a phenomenon in which the entrance of high luminance light causes a drop in gray scale and darkens the image. When incident light has a high luminance, electric charges overflow from the photodiode PD to the floating diffusion node FD, thereby lowering a voltage that the floating diffusion node FD has in the reset. If electric charges of the photodiode PD are subsequently transferred to the floating diffusion node FD, the voltage of the floating diffusion node FD which is already low is saturated and hardly changes any longer. This makes the difference between the pixel signal at the time of reset and the pixel signal after the transfer of electric charges small, which causes a drop in gray scale and the darkening of an image that is obtained by correlated double sampling. According to this embodiment, the darkening phenomenon can be diminished. The difference from the second embodiment is described mainly below.

The dummy pixel 110 in this embodiment has, in addition to the components of the dummy pixel 110 in the second embodiment, a multiplexer SW3, which is controlled with a signal φDM3. When the signal φDM3 is at the low level, the gate of the dummy pixel transistor M23 is electrically connected to one of the terminals of the capacitance C2. When the signal φDM3 is at the high level, the gate of the dummy pixel transistor M23 is electrically connected to a power supply voltage (reference voltage) VN.

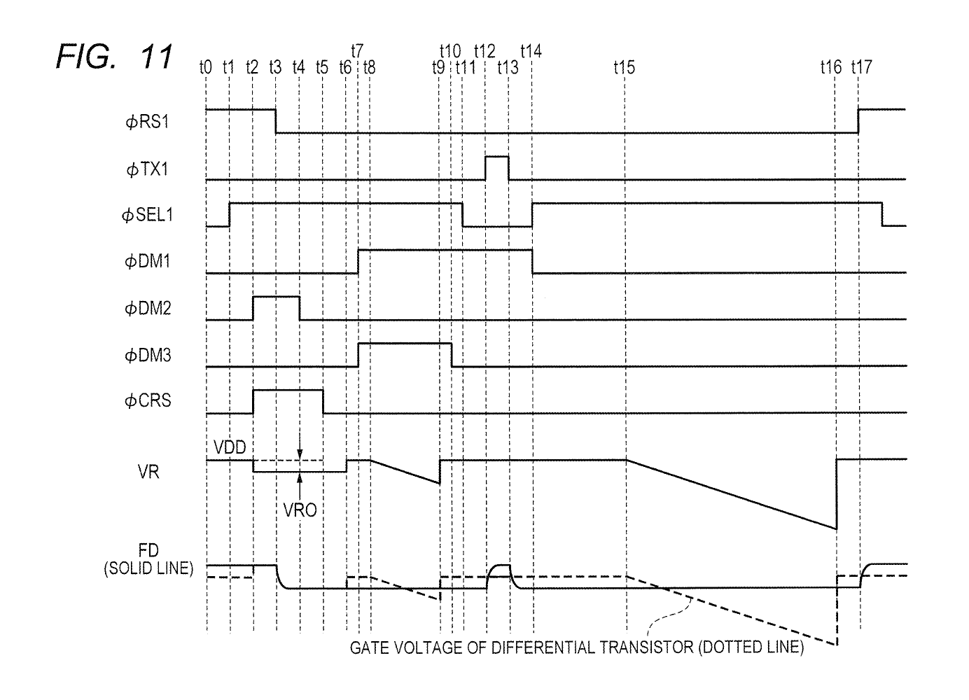

FIG. 11 is a timing chart of the pixel signal reading operation in this embodiment. At the time t0, the signal φRS1 is at the high level. At the time t1, the signal φSEL1 shifts to the high level, and a voltage that the floating diffusion node FD has at the time of the reset is output. At the time t2, the signal φCRS reaches the high level and the differential amplifier functions as a voltage follower. With the signal φDM2 at the high level and the signal φDM3 at the low level, the voltage from the output terminal OUT is applied to the gate of the dummy pixel transistor M23. In other words, the gate of the dummy pixel transistor M23 is given the same voltage as that of the floating diffusion node FD.

At the time t3, the signal φRS1 shifts to the low level and the floating diffusion node FD has a voltage lower than the reset voltage VRS due to field-through noise. At the time t4, the signal φDM2 shifts to the low level and the capacitance C2 holds the same voltage as that of the floating diffusion node FD. At the time t5, the signal φCRS shifts to the low level and the differential amplifier functions as a comparator. At the time t6, the reference signal generating unit 41 outputs the reference signal VR that has the power supply voltage VDD.

At the time t7, the signal φDM3 shifts to the high level and the power supply voltage VN is applied to the gate of the dummy pixel transistor M23. The signal φDM1 shifts to the high level at the same time, thereby turning on the transistor M24 of the dummy pixel 110. In other words, the pixel 10 and the dummy pixel 110 are electrically connected to the vertical signal lines VL1 and VL2. In a period from the time t8 to the time t9, one of the voltage of the floating diffusion node FD of the selected pixel 10 and the power supply voltage VN that is higher is compared to the reference signal VR to execute N-conversion. At the time t10, the signal φDM3 shifts to the low level and the voltage of the capacitance C2 (the voltage of the floating diffusion node FD) is applied to a base of the dummy pixel transistor M23.

After the signal φSEL1 shifts to the low level at the time t11, a shift of the signal φTX1 to the high level at the time t12 causes a transfer of electric charges of the photodiode PD to the floating diffusion node FD. The signal φTX1 shifts to the low level at the time t13 and the signal φSEL1 shifts to the high level at the time t14. A shift of the signal φDM1 to the low level at the same time turns off the transistor M24 of the dummy pixel 110. In a subsequent period from the time t15 to a time t16, the voltage of the floating diffusion node FD in the selected pixel 10 is compared to the reference signal VR to complete S-conversion.

In this embodiment, the signal φDM3 is at the high level during a period that contains the N-conversion (a period from the time t7 to the time t10). The signal φDM1 shifts to the high level at the same time as the shift of the signal φDM3 to the high level, and maintains the high level till the time t14, which is past the transfer of electric charges in the photodiode PD. This makes both the selected pixel 10 and the dummy pixel 110 active in the N-conversion period. One of the voltage of the floating diffusion node FD of the selected pixel 10 and the power supply voltage VN that is higher is compared to the reference signal VR in this case. When the voltage of the floating diffusion node FD drops lower than the power supply voltage VN, the pixel transistor M3 is turned off. Accordingly, setting the power supply voltage VN to an appropriate level accomplishes pseudo-reduction of the signal voltage to the power supply voltage VN after the floating diffusion node FD is reset, despite a drop of the voltage of the floating diffusion node FD. In other words, when light having a high luminance is irradiated and the voltage of the floating diffusion node FD at the time of the reset is lower than the power supply voltage VN, N-conversion is executed by comparing the power supply voltage VN to the reference signal VR. The darkening phenomenon is therefore diminished in an image obtained by correlated double sampling. In addition, connecting the power supply voltage VN to the gate of the dummy pixel transistor M23 in the N-conversion period does not hinder the effect of reducing common source voltage fluctuations in pixel transfer. This embodiment thus provides, in addition of the effects of the second embodiment, the effect of diminishing the darkening phenomenon at a high luminance.

### Eighth Embodiment

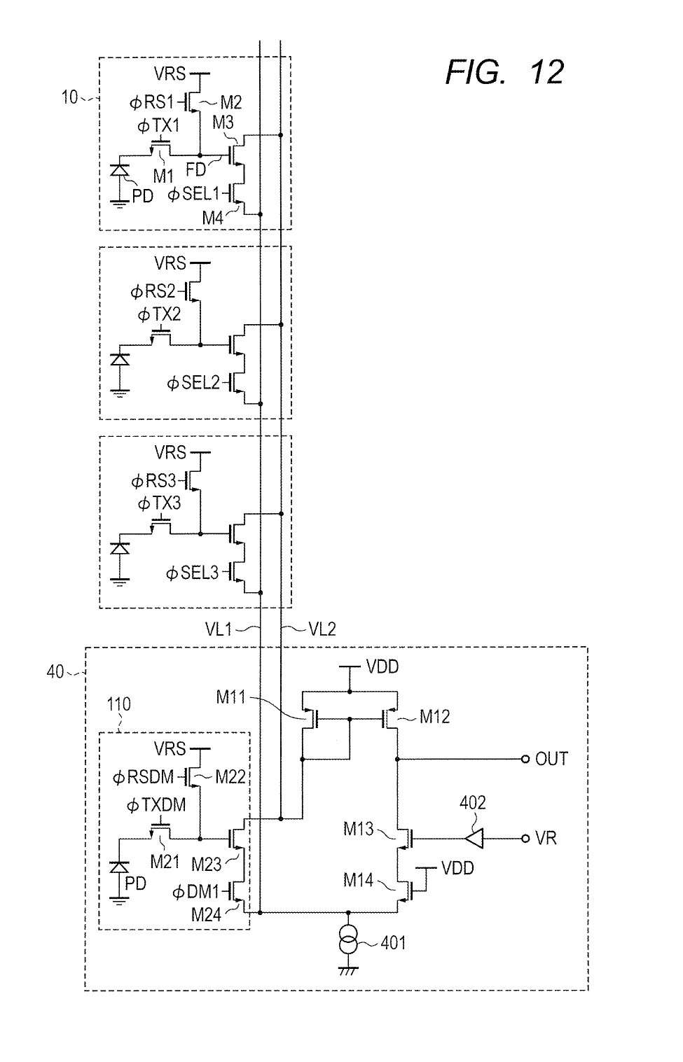

FIG. 12 is a circuit diagram for illustrating one column of the pixel array 1 and the comparator 40 for the column in an eighth embodiment of the present invention. This embodiment differs from the first embodiment in the configuration of the dummy pixel 110. The differences from the first embodiment are described mainly below.

The dummy pixel 110 in this embodiment configured the same way as the pixel 10, and includes, in addition to the dummy pixel transistor M23, a photodiode PD, a dummy pixel transfer transistor M21, a dummy pixel reset transistor M22, and a dummy pixel selection transistor M24. A signal φTXDM is supplied to a gate of the dummy pixel transfer transistor M21, and a shift of the signal φTXDM to the high level turns the dummy pixel transfer transistor M21 on. A signal φRSDM is supplied to a gate of the dummy pixel reset transistor M22. A shift of the signal φRSDM to the high level turns the dummy pixel reset transistor M22 on, and the gate voltage of the dummy pixel transistor M23 is reset to the reset voltage VRS.

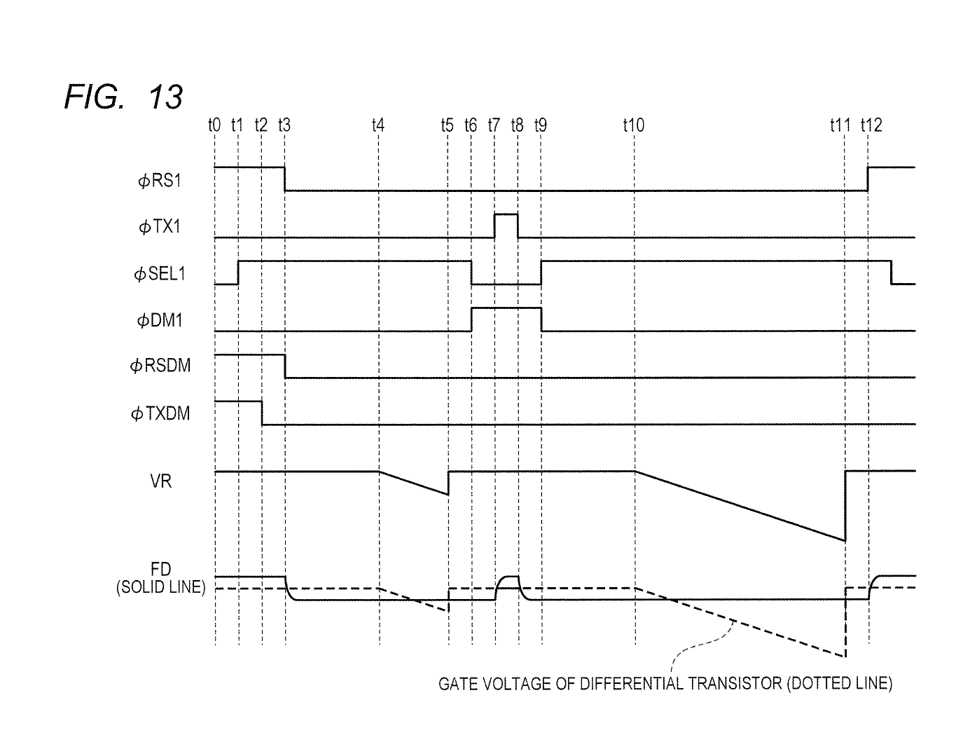

FIG. 13 is a timing chart of the pixel signal reading operation in this embodiment. At the time t0, the signal φRSDM and the signal φTXDM are at the high level, and the photodiode PD of the dummy pixel 110 and the gate voltage of the dummy pixel transistor M23 are reset. At the time t2, a shift of the signal φTXDM to the low level turns the dummy pixel transfer transistor M21 off. At the time t3, the signal φRS1 shifts to the low level and the signal φRSDM shifts to the low level as well. The gate voltage of the dummy pixel transistor M23 fluctuates at this point the same way that the floating diffusion node FD of the selected pixel 10 fluctuates in voltage. In short, the gate voltage of the dummy pixel transistor M23 drops lower than the reset voltage VRS due to the field-through noise of the signal φRS1. In a period from the time t4 to the time t5, the voltage of the floating diffusion node FD of the selected pixel 10 is compared to the reference signal VR to execute N-conversion. In a period from the time t6 to the time t9, the signal φSEL1 shifts to the low level, the signal φDM1 shifts to the high level, and a differential pair is formed from the differential transistor M13 and the dummy pixel transistor M23. In a period from the time t7 to the time t8, the signal φTX1 shifts to the high level and, while the voltage of the floating diffusion node FD fluctuates, common source voltage fluctuations of the comparator 40 are reduced by the dummy pixel 110. In a period from the time t10 to the time t11, S-conversion is executed, and the signal φRSDM and the signal φTXDM are kept at the low level. The signal φRS1 shifts to the high level at the time t12. Thereafter, the signal φRSDM and the signal φTXDM are set to the high level for the reading of the next row.

In this embodiment also, the gate voltage of the dummy pixel transistor M23 is equivalent to a voltage that the floating diffusion node FD has after the pixel reset, until the substitute current period, which includes the electric charge transfer period (a period from the time t6 to the time t9) is finished. This means that the dummy pixel 110 in this embodiment is also capable of reducing common source voltage fluctuations of the comparator 40, and that the same effects as those in the second embodiment are obtained. While the dummy pixel 110 in this embodiment includes the photodiode PD, the same effects are obtained with a null pixel, which does not include a photodiode.

### Ninth Embodiment

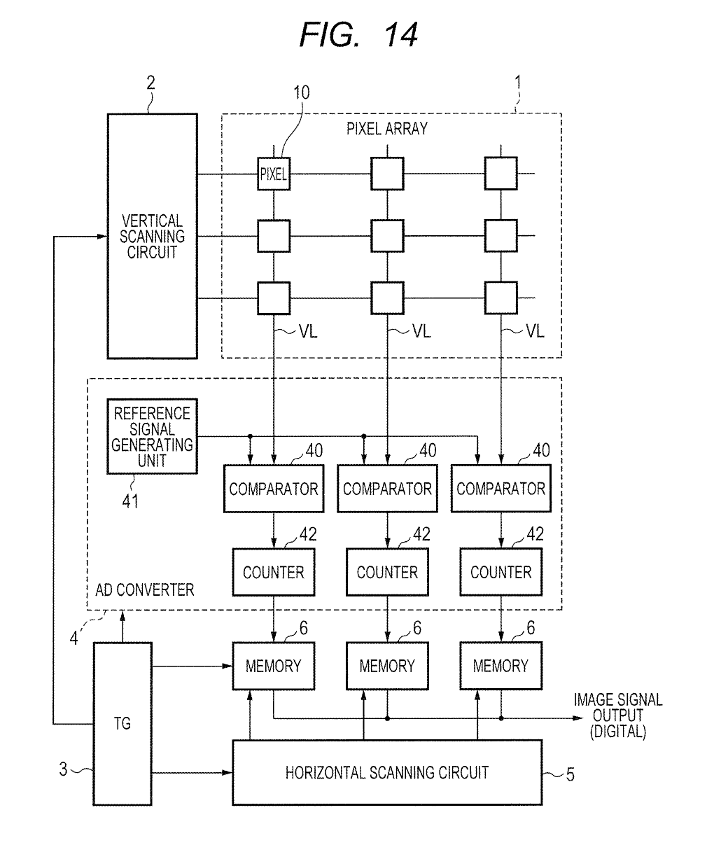

FIG. 14 is a circuit block diagram of an image pickup apparatus in a ninth embodiment of the present invention. This embodiment differs from the first embodiment in the configuration of the counter 42. Specifically, the counter 42, which is shared throughout all columns to execute AD conversion in the first embodiment, is provided for each column in this embodiment. Each counter 42 counts down in N-conversion, and counts up in S-conversion. The counter value of the counter 42 after S-conversion therefore indicates a difference between the pixel signal converted by the S-conversion and the pixel signal converted by the N-conversion. This embodiment can also provide the same effects as those in the first embodiment.

### Tenth Embodiment

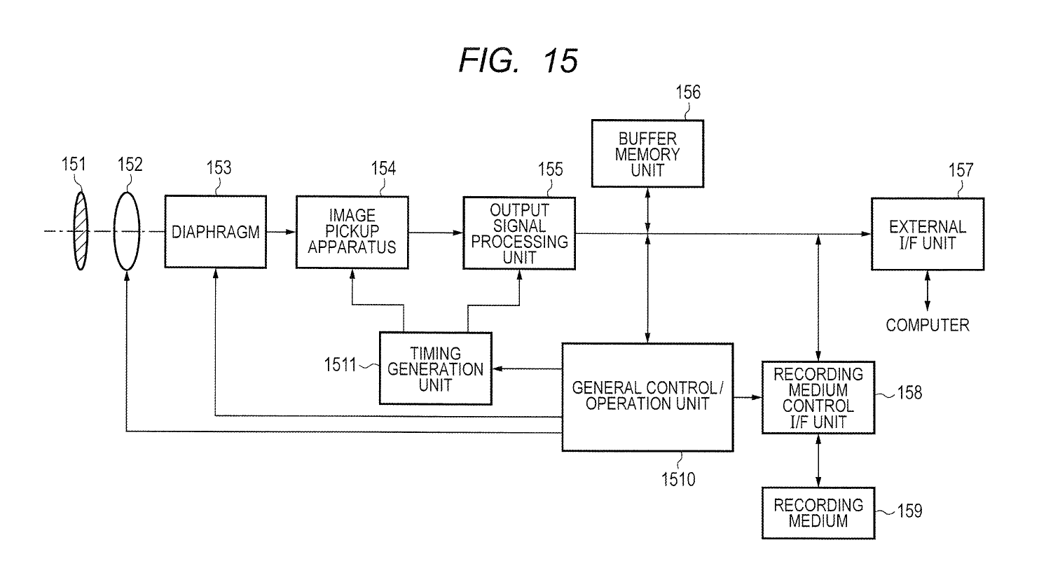

The image pick up apparatus of the embodiments described above are applicable to various image pickup systems. Examples of the image pickup systems include digital still cameras, digital camcorders, and monitoring cameras. FIG. 15 is a diagram of a digital still camera as an example of an image pickup system to which the image pickup apparatus of one of the embodiments is applied.

The image pickup system illustrated as an example in FIG. 15 includes an image pickup apparatus 154, a barrier 151 configured to protect a lens 152, the lens 152 configured to form an optical image of a subject in the image pickup apparatus 154, and a diaphragm 153 configured to vary the amount of light that is transmitted through the lens 152. The lens 152 and the diaphragm 153 form an optical system configured to collect light in the image pickup apparatus 154. The image pickup apparatus 154 is one of the image pickup apparatus of any of the embodiments described above. The image pickup system of FIG. 15 also includes an output signal processing unit 155 configured to process an output signal that is output from the image pickup apparatus 154. The output signal processing unit 155 generates an image based on a signal that is output from the image pickup apparatus 154. Specifically, the output signal processing unit 155 executes, if necessary, additional processing including various corrections and compression, and then outputs image data. The output signal processing unit 155 also executes focal point detection with the use of a signal output from the image pickup apparatus 154.

The image pickup system of FIG. 15 further includes a buffer memory unit 156 in which image data is stored temporarily, and an external interface unit (external I/F unit) 157 configured to hold communication to and from an external computer or the like. The image pickup system also includes a recording medium 159 such as a semiconductor memory in which picked-up image data is read and recorded, and a recording medium control interface unit (recording medium control I/F unit) 158 configured to record and read data in the recording medium 159. The recording medium 159 may be built in the image pickup system or may be a removable medium.

The image pickup system further includes a general control/operation unit 1510 configured to perform various types of computation and overall control of the digital still camera, and a timing generation unit 1511 configured to output various timing signals to the image pickup apparatus 154 and the output signal processing unit 155. The timing signals and other signals may be input from the outside, and the image pickup system only need to include at least the image pickup apparatus 154 and the output signal processing unit 155 configured to process an output signal that is output from the image pickup apparatus 154.

As described above, the image pickup system of this embodiment is capable of image pickup operation with the use of the image pickup apparatus 154.

### Other Embodiments

While an image pickup apparatus in the present invention has been described, the present invention is not limited to the embodiments given above, and the embodiments are not to inhibit suitable modifications and variations that fit the spirit of the present invention. For example, some of the configurations of the first embodiment to the tenth embodiment may be combined. The polarities of the N-channel MOS transistors and the P-channel MOS transistors in the embodiments may be switched so that a transistor that is an N-channel MOS transistor in the embodiments is instead a P-channel MOS transistor. As described in the first embodiment, each pixel 10 is not limited to a four-transistor configuration and may have a three-transistor configuration, which does not include a selection transistor.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2015-079804, filed Apr. 9, 2015, which is hereby incorporated by reference herein in its entirety.

What is claimed is:

1. An image pickup apparatus, comprising:
a plurality of pixels each comprising a transfer transistor configured to transfer electric charges that are generated by photoelectric conversion, a pixel transistor having a gate to which the electric charges are input, and a reset transistor configured to reset the gate of the pixel transistor;
a differential amplifier comprising a differential transistor and a current source, the differential transistor forming a differential pair with the pixel transistor and having a gate to which a ramp signal is input, the current source being electrically connected to the differential pair; and
a dummy pixel comprising a dummy pixel transistor in which one main node is electrically connected to one main node of the pixel transistor, and another main node is electrically connected to another main node of the pixel transistor.

2. An image pickup apparatus according to claim
wherein each of the plurality of pixels further comprises a selection transistor on an electrical path between the another main node of the pixel transistor and the current source, and
wherein a dummy pixel selection transistor is provided on an electrical path between the another main node of the dummy pixel transistor and the current source.

3. An image pickup apparatus according to claim 2,
wherein the another main node of the pixel transistor is connected via the selection transistor to a first signal line, the one main node of the pixel transistor is connected to a second signal line, the differential transistor and the pixel transistor form the differential pair with the first signal line as a common source, and the current source is connected to the first signal line, and
wherein, in a period where one of the reset transistor and the selection transistor is turned on, the dummy pixel transistor forms a differential pair with the differential transistor in place of the pixel transistor so that the dummy pixel transistor causes, in the differential amplifier, a flow of current that is a substitute for a current of the pixel transistor.

4. An image pickup apparatus according to claim 3, wherein, in the period, a voltage equivalent to a voltage at the time of resetting of the gate of the pixel transistor is applied to a gate of the dummy pixel transistor.

5. An image pickup apparatus according to claim 4,
wherein the ramp signal is input to the gate of the differential transistor via a first capacitance, and
wherein, when the gate of the pixel transistor is reset, the gate of the differential transistor and one main node of the differential transistor are short-circuited so that the differential amplifier operates as a voltage follower to hold a voltage equivalent to the voltage at the time of resetting of the gate of the pixel transistor, in a second capacitance which is connected to the gate of the dummy pixel transistor.

6. An image pickup apparatus according to claim 5,
wherein, in the period, the selection transistor is turned on and the voltage at the time of resetting of the gate of the pixel transistor is simultaneously converted by analog-to-digital conversion, and
wherein, in the period, a reference voltage is applied to the gate of the dummy pixel transistor and, when a voltage of the gate of the pixel transistor is lower than the reference voltage, the pixel transistor is turned off.

7. An image pickup apparatus according to claim 3,
wherein the dummy pixel further comprises a dummy pixel transfer transistor, a dummy pixel reset transistor, and a dummy pixel selection transistor, and
wherein until the end of a period in which the transfer transistor is turned on, after the dummy pixel reset transistor is turned on to reset a voltage of the gate of the dummy pixel transistor, the dummy pixel transfer transistor is in an off state.

8. An image pickup apparatus according to claim 1, wherein a counter having a counter value that is in synchronisation with the ramp signal is provided for each column of pixels.

9. An image pickup apparatus according to claim 1, further comprising a first transistor, which is connected to one main node of the differential transistor.

10. An image pickup apparatus according to claim 9, further comprising a second transistor, which is connected to the one main node of the dummy pixel transistor,
wherein the first transistor and the second transistor form a current mirror pair.

11. An image pickup system, comprising:
an image pickup apparatus, and
a signal processing unit configured to generate an image using a signal that is output from the image pickup apparatus,
the image pickup apparatus comprising:
a plurality of pixels each comprising a transfer transistor configured to transfer electric charges that are generated by photoelectric conversion, a pixel transistor having a gate to which the electric charges are input, and a reset transistor configured to reset the gate of the pixel transistor;
a differential amplifier comprising a differential transistor and a current source, the differential transistor forming a differential pair with the pixel transistor and having a gate to which a ramp signal is input, the current source being electrically connected to the differential pair; and
a dummy pixel comprising a dummy pixel transistor in which one main node is electrically connected to one main node of the pixel transistor, and another main node is electrically connected to another main node of the pixel transistor.

12. A method of driving an image pickup apparatus, the image pickup apparatus comprising:
a plurality of pixels each comprising a transfer transistor configured to transfer electric charges that are generated by photoelectric conversion, a pixel transistor having a gate to which the electric charges are input, and a reset transistor configured to reset the gate of the pixel transistor; and
a differential amplifier comprising a differential transistor and a current source, the differential transistor forming a differential pair with the pixel transistor and having a gate to which a ramp signal is input, the current source being configured to supply a current that flows in the differential pair,
the method comprising:
allowing, in a period where one of the reset transistor and the transfer transistor is turned on, a dummy pixel transistor to form a differential pair with the differential transistor in place of the pixel transistor so that the dummy pixel transistor causes, in the differential amplifier, a flow of current that is a substitute for a current of the pixel transistor; and
executing analog-to-digital conversion of a voltage of the gate of the pixel transistor based on a result of a comparison that is performed by the differential amplifier on the voltage of the gate of the pixel transistor and the ramp signal.
